(19) United States
(12) Patent Application Publication
(10) Pub. No.: US 2026/0196368 A1
(43) Pub. Date: Jul. 9, 2026

(54) SMALL MODERATED NUCLEAR REACTORS

(71) Applicant: Triad National Security, LLC, Los Alamos, NM (US)

(72) Inventors: Venkateswara Rao Dasari, Los Alamos, NM (US); Holly Renee Trellue, Los Alamos, NM (US); Andrew James Fallgren, Los Alamos, NM (US); Mikaela E. Blood, Los Alamos, NM (US)

(21) Appl. No.: 19/550,773

(22) Filed: Feb. 26, 2026

Related U.S. Application Data
(62) Division of application No. 18/420,934, filed on Jan. 24, 2024.
Application No. 18/420,934 is a continuation of application No. 17/461,868, filed on Aug. 30, 2021, now abandoned.
(60) Provisional application No. 63/072,288, filed on Aug. 31, 2020.

(51) Int. Cl. G21C 5/16; G21C 5/02; G21C 5/12; G21C 15/257

(52) U.S. Cl. CPC G21C 5/16; G21C 5/02; G21C 5/12; G21C 15/257

(57) ABSTRACT

Moderated nuclear reactors are disclosed. Hydrided moderator materials may be used to reduce fuel mass and costs. The reactor designs may be based on a unit geometry that includes a combination of fuel that includes nuclear material, moderator(s) that moderate neutrons, and heat pipes for thermal heat removal. The nuclear reactors may have a snowflake geometry or an opal geometry, for example. Low enrichment fuel of less than or equal to 19.75% may be used.

### CROSS-REFERENCE TO RELATED APPLICATION

This application is a divisional of U.S. application Ser. No. 18/420,934, filed Jan. 24, 2024, which is a continuation of U.S. application Ser. No. 17/461,868, filed Aug. 30, 2021, which claims the benefit of U.S. Provisional Patent Application No. 63/072,288, filed Aug. 31, 2020. The subject matter of each of these applications is hereby incorporated by reference in its entirety.

### STATEMENT OF FEDERAL RIGHTS

The United States government has rights in this invention pursuant to Contract No. 89233218CNA000001 between the United States Department of Energy and Triad National Security, LLC for the operation of Los Alamos National Laboratory.

### FIELD

The present invention generally relates to nuclear reactors, and more specifically, to moderated nuclear reactors.

### BACKGROUND

Relatively small nuclear reactors, such as microreactors, provide an attractive technology option for producing relatively small amounts of power (e.g., 0.05 to 20 megawatts thermal (MWt)) as an affordable nuclear energy option for a range of applications, such as space power, mining or other industry applications (e.g., oil exploration), defense, remote power, and disaster relief. Various microreactor designs are possible with varying characteristics, such as varying the neutron energy spectra, structural compositions, and/or heat removal source. However, existing space reactor designs require relatively high uranium enrichment levels. Accordingly, improved nuclear reactor designs may be beneficial.

### SUMMARY

Certain embodiments of the present invention may provide solutions to the problems and needs in the art that have not yet been fully identified, appreciated, or solved by conventional nuclear reactor technologies. For example, some embodiments of the present invention pertain to moderated nuclear reactors. The improved nuclear reactor designs of some embodiments may beneficially only require use of low enriched uranium. In particular, the fuel required for the designs of such embodiments may have a low enrichment (i.e., less than 19.75%) high-assay low enriched uranium (HALEU) or even commercial grade uranium (less than 5%). This presents less of a proliferation concern than highly enriched uranium.

In an embodiment, a nuclear reactor includes a plurality of units. At least one of the plurality of units includes a monolith and a plurality of heat pipes, a plurality of fuel rods, and a plurality of moderator rods contained within the monolith. At least some of the plurality of moderator rods surround the plurality of heat pipes and the plurality of fuel rods on an outer portion of the unit. The plurality of fuel rods include uranium molybdenum, uranium nitride, uranium oxide, tristructural-isotopic (TRISO) fuel with kernels of uranium, HALEU with less than 19.75% enrichment, commercial grade uranium with less than 5% enrichment, or a combination thereof.

In another embodiment, a nuclear reactor unit includes a moderated monolith, a plurality of heat pipes, and a plurality of fuel rods within the moderated monolith. The plurality of fuel rods include uranium molybdenum, uranium nitride, uranium oxide, TRISO fuel with kernels of uranium, HALEU with less than 19.75% enrichment, commercial grade uranium with less than 5% enrichment, or a combination thereof.

In yet another embodiment, a nuclear reactor unit includes a monolith. The nuclear reactor unit also includes a plurality of heat pipes, a plurality of fuel rods, and a plurality of moderator rods contained within the monolith. At least a portion of the plurality of moderator rods surround the plurality of heat pipes and the plurality of fuel rods on an outer portion of the nuclear reactor unit.

In still another embodiment, a nuclear reactor unit includes a monolith. The nuclear reactor unit also includes a plurality of heat pipes, a plurality of fuel rods, and a plurality of moderator rods contained within the monolith. At least a portion of the plurality of moderator rods surround the plurality of heat pipes and the plurality of fuel rods on an outer portion of the nuclear reactor unit. The plurality of fuel rods include uranium molybdenum, uranium nitride, uranium oxide, TRISO fuel with small kernels of uranium, HALEU with less than 19.75% enrichment, commercial grade uranium with less than 5% enrichment, or a combination thereof.

In another embodiment, a nuclear reactor unit includes a moderated monolith. Then moderated monolith includes a matrix of moderator material that moderates neutrons.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a top cutaway view illustrating a snowflake reactor cell, according to an embodiment of the present invention.

FIG. 2A is a top cutaway view illustrating a 91-cell nuclear reactor that includes 84 snowflake reactor cells, according to an embodiment of the present invention.

FIG. 2B is a top cutaway view illustrating the nuclear reactor of FIG. 2A without moderator rods on the periphery of the outer snowflake reactor cells, according to an embodiment of the present invention.

FIG. 3 illustrates neutron flux (n/cm²-s) as a function of position for the nuclear reactor of FIG. 2, according to an embodiment of the present invention.

FIG. 4A is a top cutaway view illustrating an opal design nuclear reactor, according to an embodiment of the present invention.

FIG. 4B is a top cutaway view illustrating the core of the opal design nuclear reactor of FIG. 4A, according to an embodiment of the present invention.

FIG. 5 is a graph illustrating the energy spectrum of various nuclear reactor types, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to moderated nuclear reactors. Moderator materials including hydrides may be used to reduce fuel mass and costs. For instance, one or more hydrides of yttrium (Y), zirconium (Zr), thorium (Th), cerium (Ce), calcium (Ca), scandium (Sc), beryllium (Be), lithium (Li), a yttrium-cerium alloy, a yttrium-gadolinium alloy, a yttrium-calcium alloy, a yttrium-cerium alloy, a yttrium-gadolinium alloy, cerium or gadolinium in solution with yttrium metal, liquid calcium hydride, cerium hydride, etc. may be used without deviating from the scope of the invention. The designs of some embodiments may be based on a unit geometry that includes a combination of fuel that includes nuclear material, moderator(s) that moderate neutrons, and heat pipes for thermal heat removal.

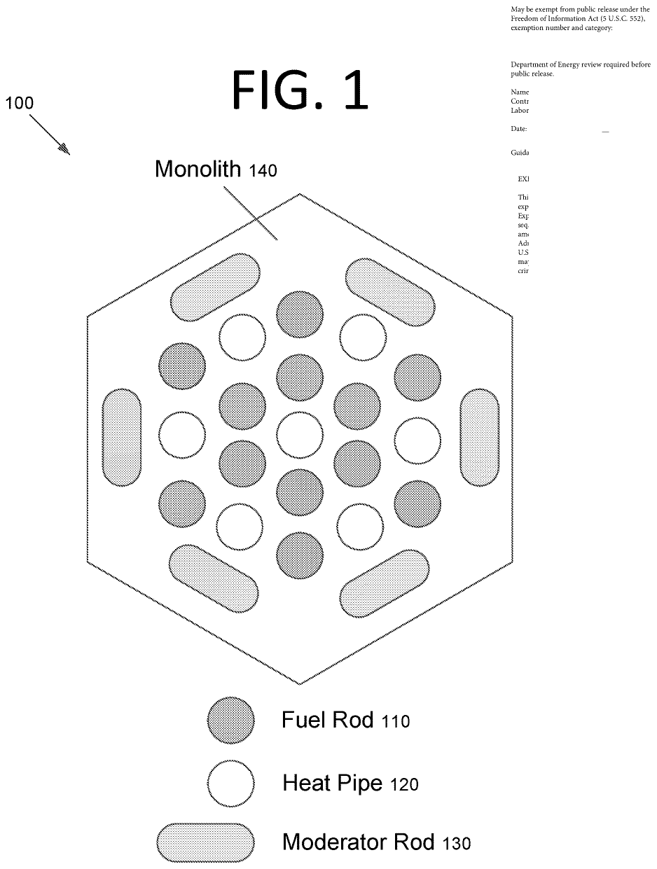

The nuclear reactors of some embodiments may have a snowflake geometry or an opal geometry, for example. Embodiments with such geometries may include a combination of “units” that are placed side-by-side to make a full core of varying sizes, depending on how many units are present. See FIG. 1, for example. Each unit may be a particular modular combination of fuel, moderator, and heat pipes. In certain embodiments, a reactor core may include two or more units that have different respective designs.

A snowflake geometry, as used herein, is a design in which fuel rods and heat pipes are intermixed with moderators between each unit. An opal geometry, as used herein, is a design in which moderator material makes up a majority of the nuclear reactor system, with fuel and heat pipes included within the moderator material. These designs are discussed in further detail in the sections below. Various fuel types may be used including, but not limited to, uranium molybdenum, uranium nitride, uranium oxide, and TRISO fuel with small kernels of uranium. One goal of some embodiments is to operate with the fuel having a relatively low enrichment of less than or equal to 19.75%, and may be HALEU or commercial grade uranium in some embodiments.

Nuclear reactor designs should be such that the feedback from increases in temperature as the reactor heats up is negative. This means that the reactivity decreases as temperature increases, causing the reactor to shut down if an accident occurs. In some embodiments, graphite-moderator-fuel volume ratios and their relative special location ensures that Doppler temperature feedback in the fuel occurs instantaneously with a change in power, followed by scattering feedback of the graphite and/or other moderators to offset the new changes in the core and allow temperatures of all materials to return to their initial values. These features may allow for multi-scale self-regulation. An innovative strategy may be employed for interspersing fuel compacts, moderators, and heat pipes in some embodiments, and the following performance may be achieved: (1) no hot spots in the reactor even with failure of two adjoining heat pipes that exceed thermal or structural limits; (2) no large thermal gradients in the moderator that might cause hydrogen redistribution which in turn could cause reactivity fluctuations; (3) separation of moderator from the fuel allows for separate cooling and/or insulating it to facilitate self-cooling; and/or (4) separation of moderator from the fuel allows for solid moderator plates (if used) to be pulled out and recycled for future use, providing cost and resource savings. Such embodiments may realize an order of magnitude of fuel savings over existing designs.

The design of some embodiments includes fuel rods and heat pipes intermixed with moderator material to create an epi-thermal spectrum and reduce required fuel mass while still preventing excessive power peaking. The inclusion of moderating material was explored: (1) in the form of moderator rods (e.g., yttrium hydride (YH_{1.8})) intermixed with heat pipes; and/or (2) as the monolith material (e.g., graphite). Hydrided material was also explored as the monolith material.

The snowflake and opal designs described herein facilitate the use of low enriched fuel, such as 19.75% or less, by using moderators embedded in cells (also called nuclear reactor units herein) of the nuclear reactor core. The moderators, which may be metallic hydrides such as yttrium hydride and/or zirconium hydride, for example, absorb or slow the thermal (fast) neutrons from fission reactions in the fuel. The slower neutrons are more readily absorbed by fissile nuclei, allowing these slower neutrons to continue the fission chain reaction at a relatively constant rate. The use of high temperature metallic hydrides provides increased fuel efficiency, which enables a low enriched fuel system of some embodiments to be competitive with the mass and volume of a highly enriched fuel system.

### Snowflake Reactor Design

To reduce the moderator volume, the concept of concentric rings of a relatively smaller number of heat pipes (e.g., 7) and fuel rods (e.g., 12) surrounded by moderator material was developed. Such a “snowflake” reactor cell 100 is shown in FIG. 1. Snowflake reactor cell 100 includes a hexagon-shaped “ring” of six fuel rods 110 surrounding a center heat pipe 120. In some embodiments, fuel rods 110 contain TRISO fuel, although any other suitable fuel may be used without deviating from the scope of the invention. In certain embodiments, the heat pipes may include 0.1 mm of sodium (by thickness) or more and 0.5 mm of a cladding material, such as molybdenum alloys or stainless steel. Outside of the ring of fuel rods 110, six alternating fuel rods 110 and heat pipes 120 are positioned and evenly spaced.

Outside of each “face” of the hexagon-shaped ring of alternating fuel rods 110 and heat pipes 120, a respective pill-shaped moderator rod 130 is located. This pill shape was chosen to increase or maximize the amount of moderator that exists between units (i.e., cells) while keeping an elongated circular shape for ease of manufacturing. However, in some embodiments, the moderator rods may have one or more other shapes including, but not limited to, circles, ovals, squares, rectangles, other regular or irregular shapes, etc. Moderator rods 130 may include hydrided material, such as yttrium dihydride (e.g., YH_{1.8}), zirconium hydride, etc. Fuel rods 110, heat pipes 120, and moderator rods 130 are located within a solid monolith 140 (e.g., a solid graphite monolith, a hydrided monolith that includes a matrix of moderator material, etc.).

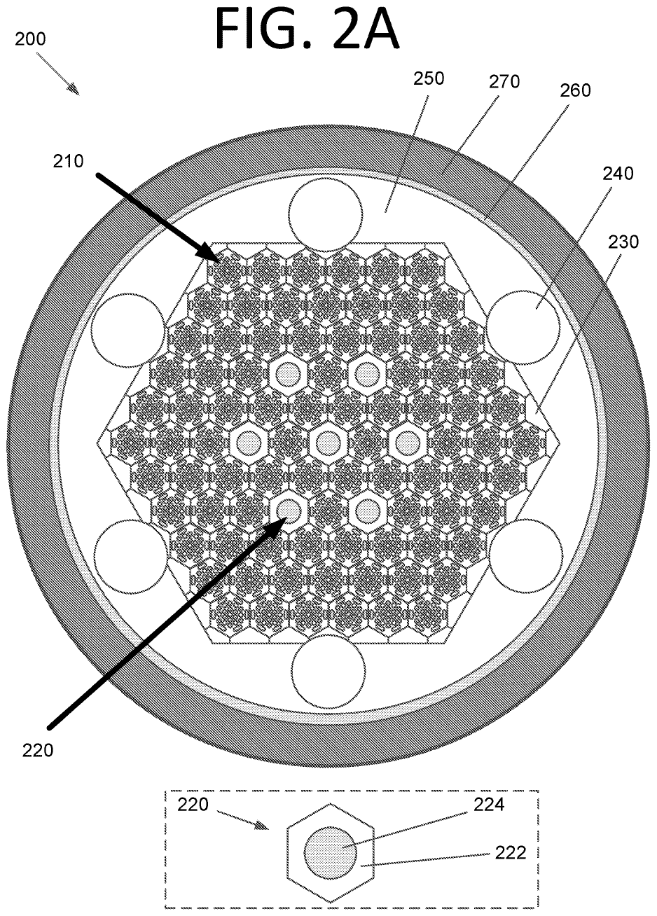

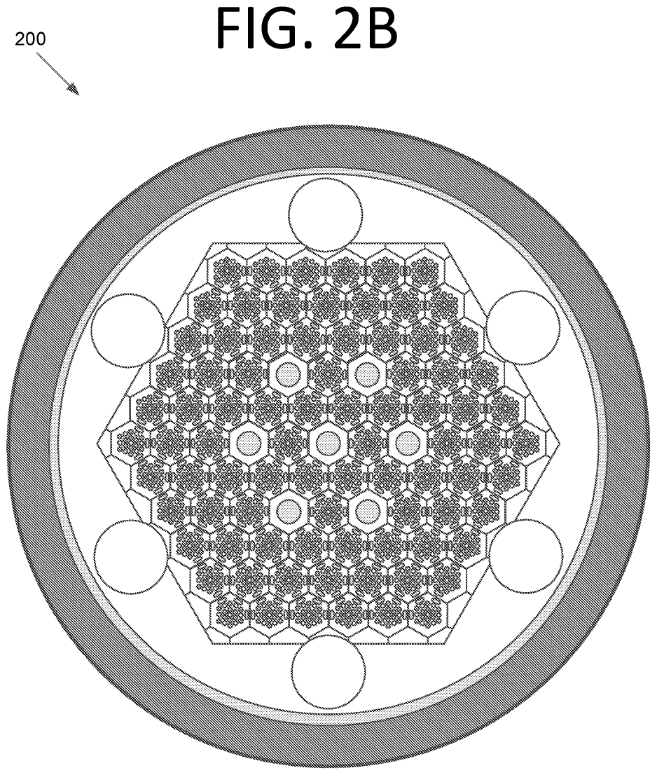

Based on the geometry of FIG. 1, in some embodiments, up to 10 kilowatts thermal (kWt) per heat pipe and 84 units can be used. See nuclear reactor 200 of FIG. 2A. With an inner heat pipe diameter of 1.6 cm, powers of up to 10 kWt should be achievable. Table 1 below lists an example of some possible parameters of nuclear reactor 200.

TABLE 1
SNOWFLAKE GEOMETRY PARAMETERS

| | | |
|---|---|---|
| Fuel rod reactivity-equivalent physical | 0.594 | cm |
| transform (RPT) homogenized radius | | |
| Inner fuel rod radius | 0.84 | cm |
| (graphite layer around RPT rod) | | |
| Outer fuel rod radius | 0.85 | cm |
| (C cladding) | | |
| Gap around fuel rod | 0.02 | cm |
| Inner diameter of heat pipe (modeled as void) | 1.59 | cm |
| Sodium thickness in heat pipe | 0.1 | mm |
| Stainless steel (SS) cladding for heat pipe | 0.35 | mm |
| YH radius of oval | 0.6 | cm |
| Clad thickness around oval (e.g., SiC cladding) | 0.1 | cm |
| Gap around oval | 0.05 | cm |
| Pitch between rods | 2.02 | cm |
| Web thickness | 2.8 | mm |
| Graphite density | 1.74 | g/cc |
| APM density | 7.4 | g/cc |
| Height of Core | 175 | cm |

| | |
|---|---|
| Operating Temperature | Up to 800° C. |

Nuclear reactor 200 includes 91 units, made up of 84 snowflake cells 310 and 7 shutdown rod cells 220. In some embodiments, snowflake cells 210 are snowflake cells 100 of FIG. 1. An enlarged view of a shutdown rod cell 220 is shown in the rectangle below nuclear reactor 200. Shutdown rod cells 220 include graphite 222 and a shutdown rod 224. Each snowflake cell and shutdown rod cell may be machined individually. Shutdown rod cells 220 are identical to one another in this embodiment, as are snowflake cells 210. However, in some embodiments, outer snowflake cells 210 do not include moderator rods at the edge of the reactor core. See FIG. 2B.

Surrounding snowflake cells 210 and shutdown rod cells 220 is a graphite web 230, which also provides a lesser degree of moderation as compared to the rods. Six B₄C control drums 240 are positioned on each face of core block 230, and are located within a BeO reflector 250. An LiH neutron shield 260 surrounds BeO reflector 250, and a depleted uranium (DU) gamma shield 270 surrounds neutron shield 260.

In a prototype embodiment, nuclear reactor 200 has a diameter of 176 cm, a height of 175 cm, a core hexagon width of 108 cm flat-to-flat, a graphite web thickness of 2.8 mm, a BeO reflector thickness of 20 cm, a neutron shield thickness of 3 cm, and a DU gamma shield thickness of 12 cm. However, any suitable size and/or number of components, and any overall reactor size, may be used without deviating from the scope of the invention. In certain embodiments, nuclear reactor 200 may have an operational lifetime of approximately three years.

This snowflake design has the advantage of separating the fuel from the moderators by the heat pipe, reducing the fuel-to-heat pipe-to-moderator ratio, and thus, reducing the overall volume of the reactor. Approximate masses of some materials in nuclear reactor 200 are given in Table 2 below.

TABLE 2
MASS OF MATERIALS IN SNOWFLAKE DESIGN

| Material | Mass (kg) |
|---|---|
| TRISO Kernel | 212 |
| Uranium Oxycarbide Fuel - (19.75% | |
| enriched HALEU) | |
| Graphite Block Surrounding Fuel | 612 |
| Graphite Monolith | 1269 |
| YH_{1.8} | 611 |
| Reflector | 2792 |
| LiH Shield | 125 |
| SS Shield | 635 |
| Gamma Shield | 16490 |

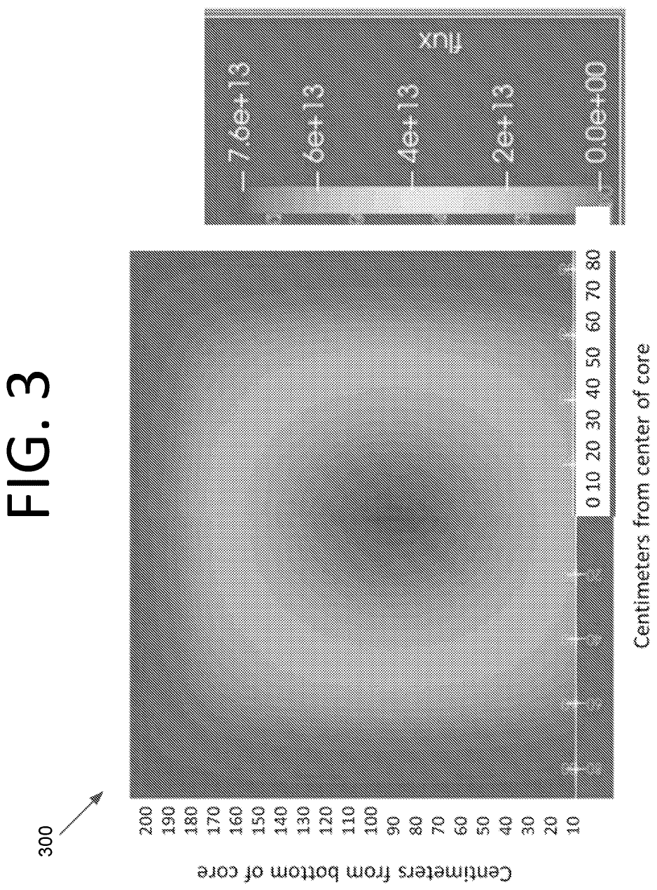

The initial k_{eff} (i.e., reactor efficiency) of the case hot at the beginning of life without control drums is about 1.078 and the total neutron flux as a function of radial position in the core is given in image 300 of FIG. 3. The control drums may be continuously adjusted to keep k_{eff} at approximately 1.0. The radial maximum-to-average neutron flux ratio is approximately 1.2.

In FIGS. 1, 2A, and 2B, cells 100, 210 have a hexagonal shape, and reactor power is readily scalable by incorporating more or fewer cells. Indeed, in some embodiments, a reactor may only include a single cell, or may have multiple or many cells (e.g., hundreds, thousands, etc.). This shape was chosen for ease of manufacturing and since a hexagonal honeycomb is geometrically optimal for stacking. However, any suitable shape, such as triangular, rectangular, etc., may be used without deviating from the scope of the invention.

### Opal Reactor Design

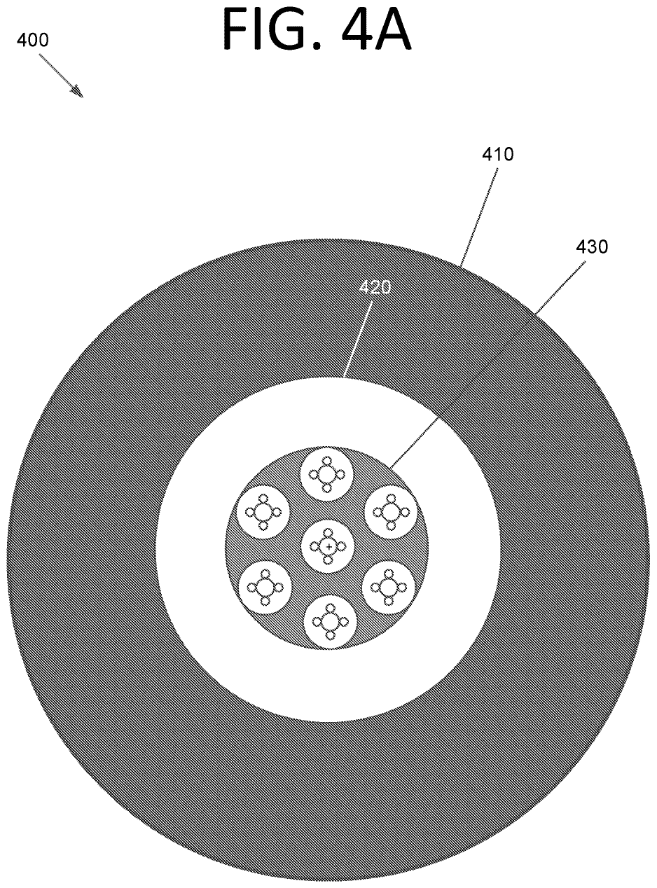

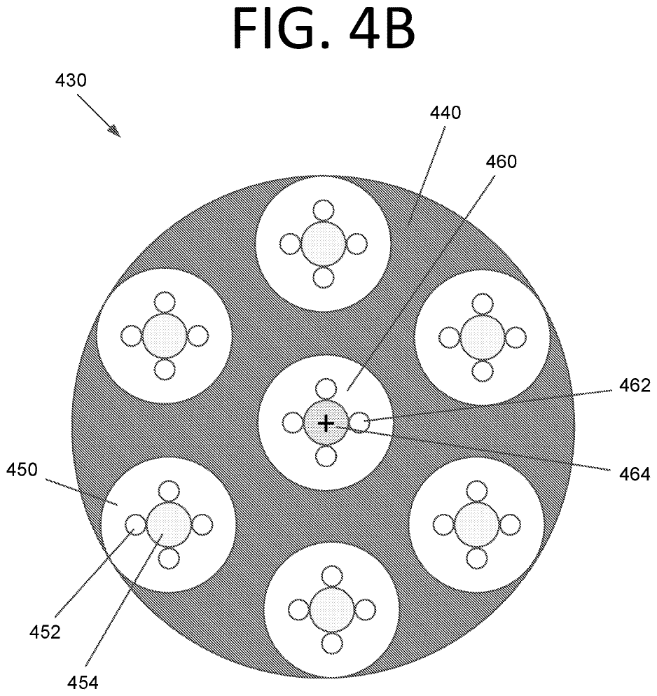

The opal design goes one step further than the snowflake design to reduce the overall size and fuel mass of a moderated unit cell design (e.g., for space reactor applications). In this design, there is no structural monolith of a metallic or ceramic material. Instead, a matrix of moderator material with fuel rods and heat pipes embedded within. In some embodiments, the matrix of moderator material may include, but is not limited to, one or more hydrides of yttrium (Y), zirconium (Zr), thorium (Th), cerium (Ce), calcium (Ca), scandium (Sc), beryllium (Be), lithium (Li), a yttrium-cerium alloy, a yttrium-gadolinium alloy, a yttrium-calcium alloy, a yttrium-cerium alloy, a yttrium-gadolinium alloy, cerium or gadolinium in solution with yttrium metal, liquid calcium hydride, cerium hydride, or a combination thereof. Such a reactor 400 is shown in FIG. 4A. Reactor 400 includes a relatively thick LiH neutron shield (e.g., at least 21 cm in thickness) surrounding a Be reflector 420 (e.g., approximately 9 cm in thickness). A reactor core 430 is surrounded by Be reflector 420. The outside of reactor core 430 is surrounded by Al₂O₃. However, it should be noted that any suitable component sizes, shapes, and/or thicknesses may be used without deviating from the scope of the invention.

FIG. 4B is an enlarged view illustrating reactor core 430. A matrix of moderator material 440 encompasses six fuel units 450 are arranged symmetrically and equidistant from one another around a control unit 460. Fuel units 450 include four heat pipes 452 surrounding a fuel rod 454 and positioned equidistant from one another. Control unit 460 also has four heat pipes 462, but instead of a fuel rod, a control rod 464 is located at the center. However, it should be noted that any number and arrangement of units, heat pipes, and/or fuel rods may be used without deviating from the scope of the invention. Mo/Al₂O₃ and burnable poison (e.g., Er₂O₃) surround heat pipes 452 and fuel rod 454 in fuel units 450 and surround heat pipes 462 and control rod 464 in control unit 460.

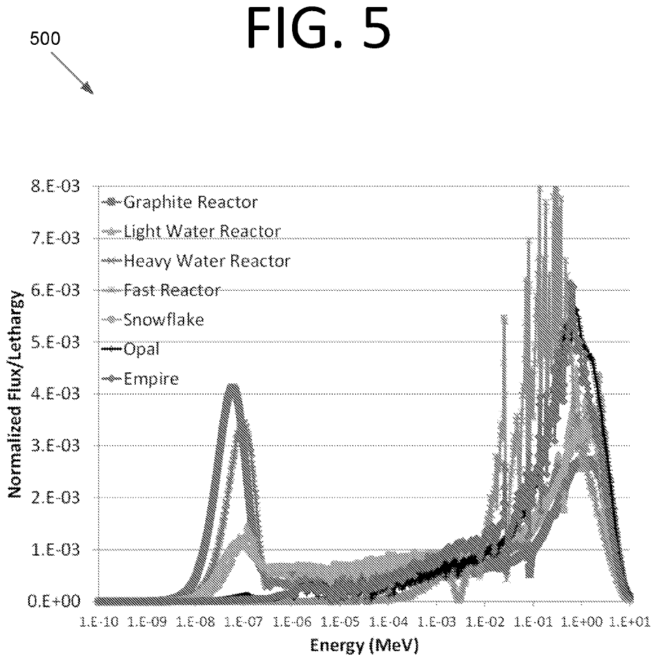

A benefit of nuclear reactor 400 and other opal designs is that the neutron energy spectrum is significantly lower (i.e., more thermal) than in other reactors. A lower neutron energy spectrum thermalizes neutrons and decreases fuel mass. This can be seen for example, in graph 500 of FIG. 5.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

In an embodiment, a nuclear reactor includes a plurality of units. At least one of the plurality of units includes a monolith and a plurality of heat pipes, a plurality of fuel rods, and a plurality of moderator rods contained within the monolith. At least some of the plurality of moderator rods surround the plurality of heat pipes and the plurality of fuel rods on an outer portion of the unit. The plurality of fuel rods include uranium molybdenum, uranium nitride, uranium oxide, TRISO fuel with kernels of uranium, HALEU with less than 19.75% enrichment, commercial grade uranium with less than 5% enrichment, or a combination thereof. In some embodiments, at least one of the plurality of moderator rods has a pill shape. In certain embodiments, a heat pipe of the plurality of heat pipes is at a center of the monolith and is surrounded by a subset of the plurality of fuel rods. Alternating heat pipes and fuel rods surround the subset of the plurality of fuel rods and the plurality of fuel rods are arranged in a plurality of lines from the heat pipe at the center of the monolith towards an outside of the monolith.

In some embodiments, at least one of the plurality of units has a snowflake geometry. In certain embodiments, a core of the nuclear reactor has an opal geometry. In some embodiments, the plurality of fuel rods include uranium molybdenum, uranium nitride, uranium oxide, TRISO fuel with kernels of uranium, or a combination thereof. In certain embodiments, the plurality of fuel rods include HALEU with less than 19.75% enrichment. In some embodiments, the plurality of fuel rods include commercial grade uranium with less than 5% enrichment. In certain embodiments, the plurality of moderator rods include one or more hydrides of yttrium (Y), zirconium (Zr), thorium (Th), cerium (Ce), calcium (Ca), scandium (Sc), beryllium (Be), lithium (Li), a yttrium-cerium alloy, a yttrium-gadolinium alloy, a yttrium-calcium alloy, a yttrium-cerium alloy, a yttrium-gadolinium alloy, cerium or gadolinium in solution with yttrium metal, liquid calcium hydride, cerium hydride, or a combination thereof.

In some embodiments, the plurality of units have a hexagonal shape and are positioned next to one another in a larger hexagonal configuration, forming a core of the nuclear reactor. In certain embodiments, the plurality of units include a plurality of snowflake cells and a plurality of shutdown rod cells. In some embodiments, outer units do not include moderator rods along one or more edges of the reactor core. In certain embodiments, the nuclear reactor includes a graphite web surrounding the plurality of units.

In another embodiment, a nuclear reactor unit includes a moderated monolith, a plurality of heat pipes, and a plurality of fuel rods within the monolith. The plurality of fuel rods include uranium molybdenum, uranium nitride, uranium oxide, TRISO fuel with kernels of uranium, HALEU with less than 19.75% enrichment, commercial grade uranium with less than 5% enrichment, or a combination thereof.

In yet another embodiment, a nuclear reactor unit includes a monolith. The nuclear reactor unit also includes a plurality of heat pipes, a plurality of fuel rods, and a plurality of moderator rods contained within the monolith. At least a portion of the plurality of moderator rods surround the plurality of heat pipes and the plurality of fuel rods on an outer portion of the nuclear reactor unit.

In still another embodiment, a nuclear reactor unit includes a monolith. The nuclear reactor unit also includes a plurality of heat pipes, a plurality of fuel rods, and a plurality of moderator rods contained within the monolith. At least a portion of the plurality of moderator rods surround the plurality of heat pipes and the plurality of fuel rods on an outer portion of the nuclear reactor unit. The plurality of fuel rods include uranium molybdenum, uranium nitride, uranium oxide, TRISO fuel with small kernels of uranium, HALEU with less than 19.75% enrichment, commercial grade uranium with less than 5% enrichment, or a combination thereof.

In another embodiment, a nuclear reactor unit includes a moderated monolith. Then moderated monolith includes a matrix of moderator material that moderates neutrons.

1. A nuclear reactor core, comprising:
a moderator material comprising a matrix of hydrided material that moderates neutrons; and
a plurality of heat pipes and a plurality of fuel rods contained within the moderator material,
wherein each fuel rod of the plurality of fuel rods is contained within a separate fuel unit disposed within the moderator material, each fuel unit comprising the respective fuel rod surrounded by a ring formed by a respective subset of the plurality of heat pipes,
wherein the moderator material is a cylinder having a circular cross section and a control unit is disposed in a radially central portion of the circular cross section of the moderator material, a control rod disposed at a center of the control unit and surrounded by a ring formed by a subset of the plurality of heat pipes, and
wherein the fuel units are disposed radially outside of the radially central portion of the moderator material containing the control unit.

2. The nuclear reactor core of claim 1, wherein the plurality of fuel rods comprises uranium molybdenum, uranium nitride, uranium oxide, tristructural-isotopic (TRISO) fuel with kernels of uranium, or a combination thereof.

3. The nuclear reactor core of claim 1, wherein the plurality of fuel rods comprises high-assay low enriched uranium (HALEU) with less than 19.75% enrichment.

4. The nuclear reactor core of claim 1, wherein the plurality of fuel rods comprises commercial grade uranium with less than 5% enrichment.

5. The nuclear reactor core of claim 1, wherein the hydrided material comprises one or more hydrides of yttrium (Y), zirconium (Zr), thorium (Th), cerium (Ce), calcium (Ca), scandium (Sc), beryllium (Be), lithium (Li), a yttrium-cerium alloy, a yttrium-gadolinium alloy, a yttrium-calcium alloy, a yttrium-cerium alloy, a yttrium-gadolinium alloy, cerium or gadolinium in solution with yttrium metal, liquid calcium hydride, cerium hydride, or a combination thereof.

6. The nuclear reactor core of claim 1, wherein the heat pipes and the fuel rod in at least one of the fuel units is surrounded by molybdenum, aluminum oxide, and erbia.

7. The nuclear reactor core of claim 1, wherein the heat pipes and the control rod of the control unit is surrounded by molybdenum, aluminum oxide, and erbia.

8. The nuclear reactor core of claim 1, wherein the fuel units are arranged symmetrically and equidistant from one another around the control unit.

9. The nuclear reactor core of claim 1, wherein the heat pipes of at least one of the fuel units are positioned equidistant from one another.

10. The nuclear reactor core of claim 1, wherein the ring formed by the subset of the plurality of heat pipes in at least one fuel unit comprises four heat pipes.

11. The nuclear reactor core of claim 1, wherein the ring formed by the subset of the plurality of heat pipes in the control unit comprises four heat pipes.

12. The nuclear reactor core of claim 1, wherein the nuclear reactor core comprises at least six fuel units.

13. A nuclear reactor comprising the nuclear reactor of claim 1.

14. The nuclear reactor of claim 13, wherein the nuclear reactor core is surrounded by a beryllium reflector.

15. The nuclear reactor of claim 14, wherein the beryllium reflector is surrounded by a lithium hydride neutron shield.
